(19) United States
(12) Patent Application Publication
(10) Pub. No.: US 2017/0345301 A1
(43) Pub. Date: Nov. 30, 2017

(54) Method for Transmitting a Vehicle Position of a Motor Vehicle to at Least One Person Outside the Vehicle as Well as Server Device and Motor Vehicle for Performing the Method

(71) Applicant: AUDI AG, Ingolstadt (DE)

(72) Inventor: Boris JURGENOWSKI, Ingolstadt (DE)

(73) Assignee: AUDI AG, Ingolstadt (DE)

(21) Appl. No.: 15/588,010

(22) Filed: May 5, 2017

(30) Foreign Application Priority Data
May 31, 2016 (DE) 102016006686.5

(51) Int. Cl. G08G 1/123; G01C 21/26

(52) U.S. Cl. CPC G08G 1/123; G01C 21/26

(57) ABSTRACT

The invention relates to a method for transmitting a vehicle position of a motor vehicle to at least one person outside the vehicle. A control device of the motor vehicle and/or a stationary server device receives contact address of the at least one person. The control device detects a predetermined operation activity of the user in the motor vehicle, generates position data, which describe a respectively current vehicle position, and sends them from the motor vehicle via a communication link to the stationary server device. The server device provides the position data retrievably on the internet via a retrieve address and the retrieve address is sent to the at least one contact address. The server device and/or the motor vehicle checks whether a predetermined deletion criterion is met and, if the deletion criterion is met, the provision of the position data is discontinued.

### TECHNICAL FIELD

The invention relates to a method for communicating or transmitting a vehicle position of a motor vehicle to at least one person outside the vehicle. The invention also includes a server device and a motor vehicle, which together as a system can perform the method according to the invention.

### BACKGROUND

During a drive with a motor vehicle, it may occur that a driver or a passenger is asked by a person outside the vehicle, for example, by telephone: “Where are you and when will you arrive?” The precise answer to this question often times presents the user (driver or passenger) with a problem. In today's motor vehicles, there is no possibility of communicating the exact position automatically to a person outside the vehicle.

The reading of the current position from a navigation device and other solutions frequently constitute an undesired distraction from the driving process. Furthermore, a precise statement is only possible with difficulty. In order to provide an update to the current situation for the person outside the vehicle at a later time, another additional telephone call is then required. Or even an interaction disadvantageous for observing traffic, using a mobile telephone or smartphone in order to write a message.

From DE 10 2012 202 827 A1 is known that means for tracking the current position of a driving vehicle in real time can be made available. For this purpose, the person outside the vehicle must generate a tracking request, which checks whether the person outside the vehicle has authorization for the tracking of the location of the driving vehicle. To this end, it is necessary that the person outside the vehicle has a code which can be used to authenticate the person. Alternatively thereto, the person can use other means of identification. This method is disadvantageous in that it requires the exchange of data for identification purposes in order to ensure that only authorized persons outside the vehicle can track the location of the vehicle.

From DE 102 27 287 A 1 is known a method for finding a parked motor vehicle again by means of a mobile end device. For this purpose, the position of the motor vehicle can be queried by means of the mobile end device.

In connection with internet services relating to social networks is known to transmit a current position of a mobile end device to a server device of the internet so that the position can be read there by other users. This is known, for example, from US 2012/0250517 A1. In doing so, it is disadvantageous that all persons involved must be connected to one another via the social network before this type of position sharing can be used.

### BRIEF DESCRIPTION OF THE DRAWINGS/FIGURES

FIG. 1 illustrates a schematic representation of a system with a motor vehicle and a server device, according to some embodiments.

### DETAILED DESCRIPTION

The invention is based on the task of communicating the current position of the motor vehicle to a person outside the vehicle with little preparation.

The task is achieved by the objects of the independent claims. Advantageous developments of the invention are described by the dependent claims, the following description, and the FIGURE.

The invention provides a method, by means of which a vehicle position of a motor vehicle is transmitted or communicated to at least one person outside the vehicle. By means of a control device of the motor vehicle, at least one contact address of at least one person is received. The at least one contact address can be described by contact data. In other words, the users themselves define the person, to whom the vehicle position is to be transmitted by specifying a contact address of the person, which contact address is appropriately received by the control device. In addition or as an alternative to entering the contact address into the control device, it can be provided that a stationary server device receives the at least one contact address. The server device can, for example, be a server of the internet.

The control device of the motor vehicle then detects a predetermined operation activity of the user in the motor vehicle. For example, this operation activity can be the operation of a button. Upon detection of the operation activity, the control device generates position data that describe a respectively current vehicle position of the motor vehicle. To this end, a receiver for a position signal, for example, of a GNSS (Global Navigation Satellite System) of a GPS (Global Positioning System) can, for example, be used in a known manner. The control device sends the position data from the motor vehicle via a communication link to the stationary server device. Thus, the respectively current vehicle position of the motor vehicle is known in the server device as the received position data are stored there.

The server device then provides the position data retrievably on the internet via a retrieve address. For example, an internet page can be generated automatically, on which page the position data are specified. The retrieve address is in this case a so-called URL (Uniform Resource Locator) or a so-called internet address. The server device sends the retrieve address to the at least one contact address of the respective person outside the vehicle. For example, an email or a message of an SMS (Short Message Service) can be sent to the person. Each person is thus informed about the retrieve address. Each person can then use the retrieve address to retrieve the position data on the internet. The server device and/or the motor vehicle subsequently checks whether a predetermined deletion criterion is met. If the deletion criterion is met, the provision of the position data is discontinued.

The invention results in the advantage that a person in the motor vehicle can specify both the recipients of the position data and the point in time from which the position data are to be made available. The user of the motor vehicle thus has complete control over when and to whom the position of the motor vehicle is provided. In the process, the persons outside the vehicle must not take any preparatory or precautionary measures as they receive a retrieve address, by means of which they can retrieve the position data on the internet. For this purpose, a traditional means, such as an internet browser, can be used.

The invention also includes advantageous developments, the features of which result in additional advantages.

As already mentioned, the position data retrievable via the retrieve address are preferably periodically updated. In this way, a single operation activity is sufficient in order to also inform the at least one person outside the vehicle about the current position of the motor vehicle for the further course of the drive.

This then applies until the deletion criterion is met. The deletion criterion in this case preferably comprises that the position data are provided for a predetermined period of time. In doing so, the position data can be updated periodically in the manner described. This deletion criterion has the advantage that the provision of the position data is automatically interrupted or discontinued, even if the user forgets that he has activated the provision of the position data.

In addition or as an alternative thereto, the deletion criterion can comprise that the motor vehicle has ended a driving cycle. The end of the driving cycle can, for example, be indicated by an ignition-off signal, i.e. when an ignition of the motor vehicle is switched off. This results in the advantage that the position data are available for the entire rest of the drive.

Afterwards, when the deletion criterion is met, the provision of the position data is stopped. The motor vehicle can realize this by discontinuing to transmit current position data. The server device can do so by deleting or removing the position data from the retrieve address.

In addition to the position data, other data, which are referred to as meta data here, are also preferably determined and received and provided at the retrieve address by the server device. The meta data preferably describe additional characteristics of the current drive. They in particular comprise an estimated arrival time, as can be provided, for example, by a navigation device, and/or a driving speed, which can be a current driving speed or an average speed, and/or a destination of the motor vehicle, as is also provided by a navigation device or can be estimated based on previous drives.

The meta data are preferably selected depending on the stored configuration data of the user. In other words, the user can define prior to performing the operation activity, which meta data are to be sent together with the position data to the server device. This results in the advantage that the user is not distracted during a drive by selecting the meta data. He can make the selection beforehand and specify it by storing the configuration data. Alternatively thereto, it can be provided that the user specifies the selection of the meta data for each operation activity before or after the same.

The position data provided at the retrieve address can be retrieved in the described manner at the retrieve address by the at least one person outside the vehicle. For this purpose, a person outside the vehicle can, for example, use a personal computer (PC) or a smartphone or a tablet PC. An internet browser can, for example, be used as software. The retrieving of the position data can be detected by the server device. Accordingly, the server device preferably determines, how many persons or which persons of the at least one person retrieve the position data from the retrieve address. The server device sends identity data, which describe the number or the at least one retrieving person, to the motor vehicle. In this way, the information as to how many and/or who has/have in fact successfully retrieved the position data is provided or available in the motor vehicle. The user thus knows whether the transmission of the position data was successful.

A possibility of determining the identity of the retrieving person is given by sending a respectively different link (reference) as retrieve address to each person. A link is a URL, which leads, for example, to an internet page. Identification data, which can be different for each person outside the vehicle, can be added to such a link. For example, a number can be added to each link. If this link is then used to query the position data, the server device receives the identification data contained in the link and can thereby detect, by whom the position data are retrieved. It is thus not necessary that the person outside the vehicle provides the identification data.

As already described, the method can be triggered with a single operation activity of the user in the motor vehicle. This operation activity can be a single operation of a button or a touch field, as can be provided, for example, on a touchscreen, in the manner described. A single operation of a button or a touch field is thus preferably detected as operation activity. This provides little distraction and can thus even be performed by a driver of the motor vehicle, for example.

The invention also includes a system for performing the method, which system comprises the server device on the one hand and the motor vehicle on the other hand.

The server device according to the invention and provided for this purpose serves to transmit position data between a motor vehicle and at least one person outside the vehicle. The server device is designed to perform the method steps, which were described here in connection with the server device. To this end, the server device can, for example, be designed as a server of the internet. The server device can comprise a processor unit, which comprises at least one microprocessor and/or at least one micro-controller. The server device furthermore comprises program code, which is designed to perform the steps relating to the server device, of the method of the invention when it is executed by the processor unit. The program code can be stored in a data storage device of the processor unit.

The motor vehicle according to the invention, which motor vehicle is part of the system, comprises the described receiving unit for receiving a position signal of the GNSS. A GPS receiver can thus, for example, be provided as a receiving direction. The motor vehicle according to the invention furthermore comprises the described control device, which is designed to perform the steps relating to the motor vehicle, of an embodiment of the method according to the invention. To this end, the server device can comprise a processor unit, which comprises at least one microprocessor and/or at least one micro-controller. The server device furthermore comprises program code, which is designed to perform the method steps relating to the motor vehicle when it is executed by the processor unit. The program code can be stored in a data storage device of the processor unit.

The motor vehicle according to the invention is preferably an automobile, in particular a passenger car or a truck.

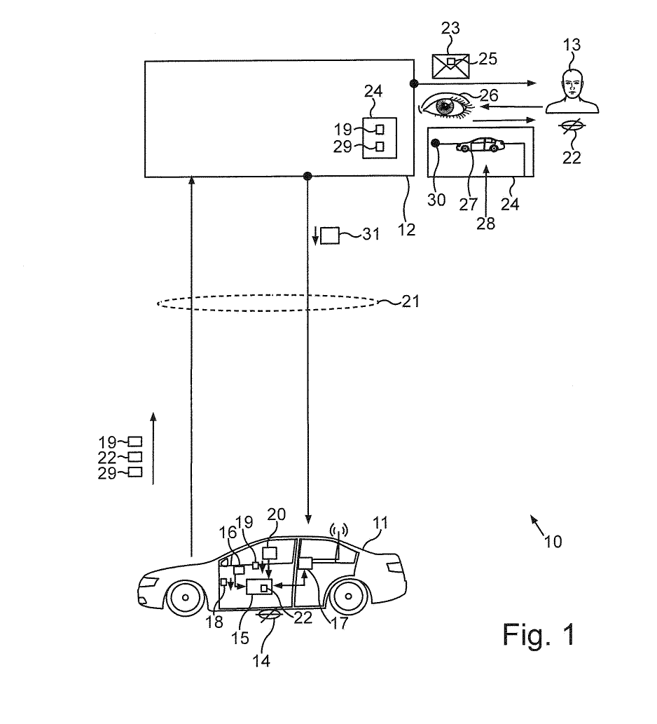

In the following, an exemplary embodiment of the invention is described. To this end, the single FIGURE (FIG. 1) shows a schematic representation of an embodiment of the system according to the invention with an embodiment of the motor vehicle according to the invention and an embodiment of the server device according to the invention.

The exemplary embodiment described is a preferred embodiment of the invention. In the exemplary embodiment, the described components of the embodiment respectively represent single features of the invention, which features are to be considered independently of one another and are respectively further developed independently of one another by the invention and which features are thus also to be considered individually or in a combination other than the one shown as a component of the invention. Additionally, the described embodiment is also expandable by additional, already described features of the invention.

FIG. 1 shows a system 10 with a motor vehicle 11 and a server device 12. By means of the system 10, a current vehicle position 14 of the motor vehicle 11 can be communicated to a person 13 outside the vehicle on a mobile end device (smartphone or tablet PC or smartwatch), for example, or a personal computer on the basis of an internet browser, for example.

The vehicle position 14 can be communicated to the person 13 from the motor vehicle 11. To this end, the motor vehicle 11 can comprise a control device 15, which can be connected to an operator unit 16 and a communication unit 17. The operator unit 16 can, for example, comprise a button or a control panel on a touchscreen. The user of the motor vehicle 11 can generate an operation signal 18 by operating the operator unit 16. This corresponds to an operation activity of the user.

Depending on the operation signal 18, the control device 15 can determine the current vehicle position 14 based on position data 19 of a receiver 20 of a position signal of a GNSS (such as a GPS), for example. By means of the communication unit 17, the control device 15 can establish a communication link 21 to the server device 12. The server device 12 can, for example, be a server of the internet. The communication link 21 can comprise a radio link between the motor vehicle 11 and a WLAN (Wireless Local Area Network) router, for example, or a mobile radio network. The communication link 21 can furthermore comprise an internet connection. For this purpose, the communication unit 17 can, for example, comprise a mobile radio module (Long-Term Evolution (LTE), Universal Mobile Telecommunications Service (UMTS), Global System for Mobile communication (GSM)) and/or a WLAN radio module.

The control device 15 can transmit the position data 19 to the server device 12 by means of the communication unit 17.

The user of the motor vehicle 11 can furthermore define at least one contact address 22 in the control device 15, for example. In other words, in the control device 15 is stored at least one contact address 22, which specifies to which person 13 the position data 19 are to be communicated. The control device 15 can also transmit the at least one contact address to the server device 12. The contact address 22 can, for example, be a telephone number in order to transmit a message 23 to the person by means of an SMS, for example. It can also be an email address in order to transmit an email as message 23.

The server device 12 can provide the position data 19 on the internet as internet page 24, for example. The message 23 can contain a link 25, i.e. a retrieve address, by means of which the person 13 outside the vehicle can, for example, trigger a retrieval 26 of the internet page 24 using an internet browser. The internet page 24 is then displayed in the internet browser for the person 13. In the process, the internet page 24 displays the position data 19 as a symbol 27 of the motor vehicle 11 on a road map 28, for example.

Additional meta data 29 can be transmitted to the server device 11 by the control device 15. The control device 12 can also integrate the meta data 29 into the internet page 24, for example. The meta data 29 can, for example, specify a destination 30 of the motor vehicle 11. The meta data can, for example, also specify an estimated arrival time at the destination 30.

By means of the retrieval 26, the server device 12 can detect, which person 13 and/or how many persons 13 retrieves/retrieve the internet page 24, i.e. view the position data 19. The server device 12 can then transmit identity data 31 to the motor vehicle 11 so that the user of the motor vehicle 11 is aware of who and how many persons has/have retrieved the position data 19 and the meta data 29.

By simply operating the operator unit 16, e.g. by means of a press of a button, a user of the motor vehicle 11 can thus transmit his current position 14 and meta data 29 to contacts or to a contact group for a certain period of time. Possible meta data are in this case the estimated arrival time (if route guidance is activated in the navigation device), the driving speed. The selection of the meta data 29 is in this case preferably configurable.

The sharing or communicating of the vehicle position 14 (and optionally of the meta data 29) can preferably be started only from the motor vehicle 11. The recipient, i.e. the person 13, then receives a URL, e.g. by SMS or generally via a communication channel, and then reaches an internet page 24, on which the person can query the position data 29 and the provided meta data 29 preferably without prior login.

In this way, delays or meeting places can, for example, be communicated to carpools, relatives, friends, and/or business partners as persons 13 outside the vehicle.

The server device 12 automatically stops the provision of the position data 19 after a predetermined period of time, which is preferably also configurable. The provision of the position data can also be stopped automatically after each driving cycle. The user of the motor vehicle 11 is notified of the position tracking or tracking by identity data 31, by means of which he also learns the number of observers.

The user of the motor vehicle 11, such as the driver, must actively request the sharing of his vehicle position 14. This is performed by the operation activity described. In the further course, the released position data 19 and optionally the meta data 29 and the selected recipient or the selected recipient group, i.e. at least one person 13, are communicated to the server device 12. Depending on the installation, the communication link 21 can, for example, provide a control device, such as a gateway or an infotainment system, which comprises for this purpose the communication unit 17 described.

After successful transmission, the server device 12 generates the web page or internet page 24 and sends the link 25 to the selected recipients or persons 13. Each person 13 has the possibility of viewing the position data 19 and other released meta data 29.

By means of the periodic transmission of the vehicle position 14 as current position data 19, the internet page 24 is always updated. After each driving cycle or after the expiration of the defined period of time, the updating of the internet page 24 is discontinued.

Overall, the example shows how a remote position sharing functionality (position transmission functionality) can be provided by the invention.

1-10. (canceled)

11. A method for transmitting a vehicle position of a motor vehicle to at least one person outside the motor vehicle, the method comprising:
transmitting, by a control device of the motor vehicle, a contact address of the at least one person;
detecting, by the control device, a predetermined operation activity of a user in the motor vehicle;
generating position data comprising a current vehicle position;
sending the position data from the motor vehicle via a communication link to a stationary server device, wherein the position data is provided by the stationary server device to the at least one person via a retrieve address and the retrieve address is sent to the contact address;
determining whether a predetermined deletion criterion is met; and
discontinuing providing the position data if the deletion criterion is met.

12. The method according to claim 11, wherein the position data provided by the stationary server device to the at least one person via the retrieve address are periodically updated.

13. The method according to claim 11, wherein the deletion criterion comprises a predetermined period of time for sending the position data.

14. The method according to claim 11, wherein the deletion criterion is met when the motor vehicle ends a driving cycle.

15. The method according to claim 11, further comprising:
determining meta data in addition to the position data; and
transmitting the meta data to the stationary server device,
wherein the meta data are provided at the retrieve address by the stationary server device, and
wherein the meta data comprises an estimated arrival time, a driving speed, or a destination of the motor vehicle.

16. The method according to claim 15, wherein the meta data are determined depending on stored configuration data of the user.

17. The method according to claim 11, further comprising:
receiving identity data from the stationary server device,
wherein the identity data comprise a number or an identity of the at least one person outside the vehicle who retrieve the position data from the retrieve address.

18. The method according to claim 11, wherein different persons outside the vehicle are sent different links as the retrieve address.

19. The method according to claim 11, wherein the detecting a predetermined operation activity comprises detecting a single operation of a button or a touch field.

20. A server device for communicating position data between a motor vehicle and at least one person outside the motor vehicle, the server device comprising:
a memory; and
at least one processor coupled to the memory and configured to:
receive a contact address of the at least one person;
receive the position data from the motor vehicle via a communication link, wherein the position data comprise a current vehicle position and are generated by a control device of the motor vehicle when the control device detects a predetermined operation activity of a user in the motor vehicle;
send, to the at least one person, the position data via a retrieve address;
determine whether a predetermined deletion criterion is met; and
discontinue sending the position data when the deletion criterion is met.

21. The server device according to claim 20, wherein the at least one processor is further configured to:
receive meta data from the motor vehicle; and
provide to the at least one person the meta data at the retrieve address,
wherein the meta data comprises an estimated arrival time, a driving speed, or a destination of the motor vehicle.

22. The server device according to claim 20, wherein the at least one processor is further configured to:
determine identity data, wherein the identity data comprise a number or an identity of the at least one person outside the vehicle who retrieve the position data from the retrieve address; and
transmit the identity data to the motor vehicle.

23. A motor vehicle, comprising:
a receiving unit configured to receive a position signal;
a memory; and
at least one processor coupled to the memory and configured to:
transmit a contact address of at least one person outside the motor vehicle;
detect a predetermined operation activity of a user in the motor vehicle;
generate position data comprising a current vehicle position;
send the position data, via a communication link, to a stationary server device, wherein the position data is provided by the stationary server device to the at least one person via a retrieve address and the retrieve address is sent to the contact address;
determine whether a predetermined deletion criterion is met; and
discontinue providing the position data when the deletion criterion is met.

24. The motor vehicle according to claim 23, wherein the at least one processor is further configured to:
determine meta data in addition to the position data; and
transmit the meta data to the stationary server device,
wherein the meta data are provided at the retrieve address by the stationary server device, and
wherein the meta data comprises an estimated arrival time, a driving speed, or a destination of the motor vehicle.

25. The motor vehicle according to claim 24, wherein the meta data are determined depending on stored configuration data of the user.

26. The motor vehicle according to claim 23, wherein the at least one processor is further configured to:
receive identity data from the stationary server device,
wherein the identity data comprise a number or an identity of the at least one person outside the vehicle who retrieve the position data from the retrieve address.

27. The motor vehicle according to claim 23, wherein the at least one processor is further configured to periodically update the position data.

28. The motor vehicle according to claim 23, wherein the deletion criterion comprises a predetermined period of time for sending the position data.

29. The motor vehicle according to claim 23, wherein the deletion criterion is met when the motor vehicle ends a driving cycle.
